(19) United States
(12) Patent Application Publication
(10) Pub. No.: US 2013/0215146 A1
(43) Pub. Date: Aug. 22, 2013

(54) IMAGE-DRAWING-DATA GENERATION APPARATUS, METHOD FOR GENERATING IMAGE DRAWING DATA, AND PROGRAM

(71) Applicant: CANON KABUSHIKI KAISHA, (US)

(72) Inventors: Minoru Kusakabe, Yokohama-shi (JP); Takuya Tsujimoto, Kawasaki-shi (JP); Hidetoshi Tsuzuki, Yokohama-shi (JP)

(73) Assignee: CANON KABUSHIKI KAISHA, Tokyo (JP)

(21) Appl. No.: 13/766,576

(22) Filed: Feb. 13, 2013

(30) Foreign Application Priority Data
Feb. 17, 2012 (JP) 2012-033154

(51) Int. Cl. G09G 5/00

(52) U.S. Cl. CPC G09G 5/00
USPC 345/629; 345/619; 345/667

(57) ABSTRACT

An image-drawing-data generation apparatus includes an image input unit, a layout storing unit, a display layout determination unit, and an image-drawing-data generation unit. The image input unit receives information about an image obtained by photographing a sample containing a cell. The layout storing unit stores a plurality of layouts. The display layout determination unit determines a display layout, from among the plurality of layouts, that is displayed when the image is to be displayed. The image-drawing-data generation unit generates image drawing data to be displayed based on the information about the image and the display layout. The plurality of layouts include a first layout for observing the image obtained by photographing the sample that holds a tissue structure, and a second layout for observing the image obtained by photographing the sample that does not hold a tissue structure.

### BACKGROUND OF THE INVENTION

1. Field of the Invention

Aspects of the present invention generally relate to an image-drawing-data generation apparatus, a method for generating image drawing data, and a program that generates image drawing data for observing multiple images obtained by photographing a sample containing cells.

2. Description of the Related Art

Heretofore, switching of a display layout for displaying an image has been performed (see PCT Japanese Translation Patent Publication No. 2007/141995). In PCT Japanese Translation Patent Publication No. 2007/141995, a method is disclosed in which, when a captured image is to be displayed, a display position is specified in a display area, and in which the display layout is changed in accordance with the specified display position.

In PCT Japanese Translation Patent Publication No. 2007/141995, a method is disclosed in which a layout is determined in accordance with the display position of an image which is specified by a user. However, especially in the case of medical images or the like, various types of images may be observed, and layouts suitable for displaying images may differ depending on the image content of or the observation purpose. In these cases, when a layout is determined on the basis of only specifying a display position for an image, a display layout suitable for an observation operation may fail to be displayed, and the efficiency of an image observation operation may be reduced.

### SUMMARY OF THE INVENTION

According to an aspect of the present invention, an image-drawing-data generation apparatus includes an image input unit, a layout storing unit, a display layout determination unit, and an image-drawing-data generation unit. The image input unit receives information about an image obtained by photographing a sample containing a cell. The layout storing unit stores a plurality of layouts. The display layout determination unit determines a display layout, from among the plurality of layouts, that is displayed when the image is to be displayed. The image-drawing-data generation unit generates image drawing data to be displayed based on the information about the image and the display layout. The plurality of layouts include a first layout for observing the image obtained by photographing the sample that holds a tissue structure, and a second layout for observing the image obtained by photographing the sample that does not hold a tissue structure.

Further features of the present invention will become apparent from the following description of exemplary embodiments with reference to the attached drawings.

### BRIEF DESCRIPTION OF THE DRAWINGS

FIG. 1 is a diagram illustrating an apparatus configuration according to an exemplary embodiment.

FIG. 2 is a diagram illustrating the configuration of a computer which switches a display layout according to an exemplary embodiment.

FIG. 3 is a diagram illustrating exemplary preparations to be photographed according to an exemplary embodiment.

FIG. 4 is a diagram illustrating exemplary preparations to be photographed according to an exemplary embodiment.

FIG. 5 is a functional block diagram of a display layout switching method according to a first embodiment.

FIG. 6 is a flowchart describing an operation flow of the display layout switching method according to the first embodiment.

FIGS. 7A and 7B are diagrams illustrating exemplary display layouts according to the first embodiment.

FIG. 8 is a functional block diagram of a display layout switching method according to a second embodiment.

FIG. 9 is a flowchart describing an operation flow of the display layout switching method according to the second embodiment.

FIGS. 10A and 10B are diagrams illustrating exemplary display layouts according to a third embodiment.

### DESCRIPTION OF THE EMBODIMENTS

Embodiments of the present invention will be described in detail below on the basis of the attached drawings. In the embodiments, when an image obtained by photographing an object is to be displayed, a display layout is determined on the basis of selection of a display mode which is performed by a user or associated information of the display image. In the embodiments, the description will be made below under the assumption that a specific application example of an image pickup apparatus which obtains an image is, for example, a microscope which captures a high-resolution still image.

### First Embodiment

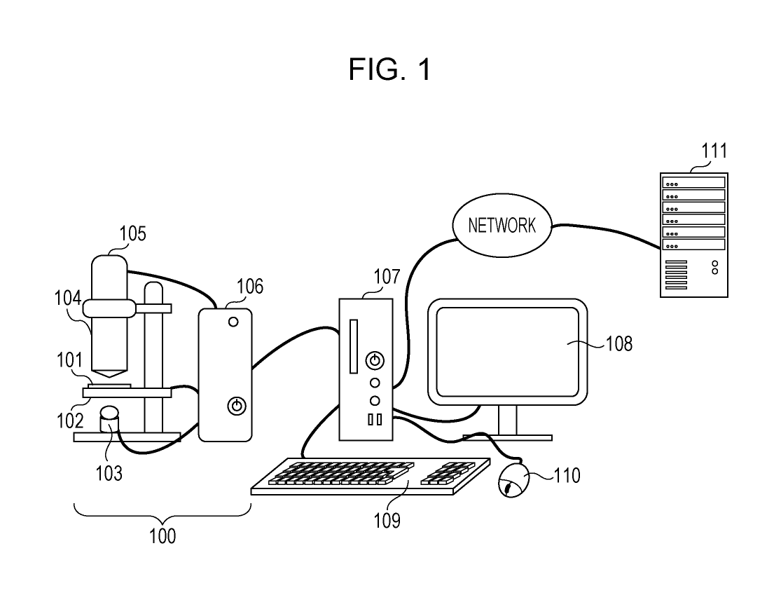

FIG. 1 illustrates an apparatus configuration according to a first embodiment. In FIG. 1, a microscope apparatus 100 is an apparatus which can capture a still image. A sample which is an object to be photographed is mounted on a preparation 101. In the first embodiment, the description will be made under the assumption that the sample is a transmissive object. The preparation 101 is mounted on a stage 102 which can move in a plane perpendicular to the optical axis direction of an objective lens 104 which is used in capturing an image. The stage 102 can also move in the optical axis direction of the objective lens 104 used in capturing an image, and can change the position in an object in the thickness direction, i.e., the focal position. Light from a light source 103 passes through the preparation 101, and enters the objective lens 104. An image pickup unit 105 picks up an image of an object which is formed by the objective lens 104. A controller 106 controls operations of, for example, the stage 102, the light source 103, and the image pickup unit 105. The objective lens 104 may be constituted by multiple lenses which are switched from one to another, or may be provided with a zoom mechanism. In this case, the controller 106 may control the switching of the lenses or the zoom mechanism. A terminal 107 is a terminal for transmitting an operation instruction to the microscope apparatus 100 and receiving captured image data. The function of the controller 106 may be achieved by the terminal 107.

A display 108 displays a screen used to designate the operation instruction for the microscope apparatus 100 to an operator, and displays information about a captured image. A keyboard 109 is used for an operator to input an operation instruction. A mouse 110 is used for an operator to input an operation instruction. A server 111 is connected to the terminal 107 via a network, and records image data captured by the microscope apparatus 100. The server 111 may be directly connected to the microscope apparatus 100 via a network, and may directly record captured image data into the server 111.

In an image display method according to the first embodiment which is performed by the terminal 107 serving as an image-drawing-data generation apparatus, display is performed by the display 108 serving as a display apparatus. The image display method according to the first embodiment may be achieved by the controller 106 by employing a configuration in which the microscope apparatus 100 includes a display and an operation instruction input unit such as buttons, in addition to the above-described configuration, and in which the function of the terminal 107 is incorporated in the controller 106. Herein, a system constituted by an image-drawing-data generation apparatus and a display apparatus is called an image-drawing-data generation system.

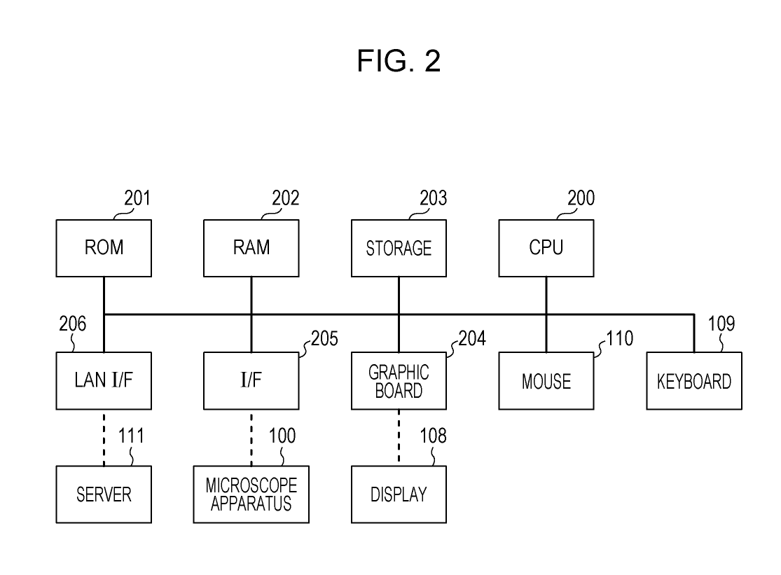

FIG. 2 illustrates an internal configuration of the terminal (computer) 107 which performs the image display method according to the first embodiment, and relationship between the terminal 107 and external equipment. A central processing unit (CPU) 200 performs calculation necessary for the process. A read-only memory (ROM) 201 stores programs and data which can be read out. A random-access memory (RAM) 202 is a RAM from which and into which programs and data necessary for the process can be written and read out. A storage 203 is a storage from which and into which programs, image data, and the like can be written and read out, and is formed by, for example, a hard disk drive (HDD) or a solid state drive (SSD). A graphic board 204 generates image drawing data to be used when a screen display is performed. An interface 205 receives/transmits data when the terminal 107 communicates with the microscope apparatus 100 which is external equipment. A LAN interface 206 receives/transmits data when the terminal 107 communicates with the server 111 connected via a network. The interface 205 or the LAN interface 206 corresponds to an image information input unit.

The embodiment described below is achieved through programs executed by the CPU 200.

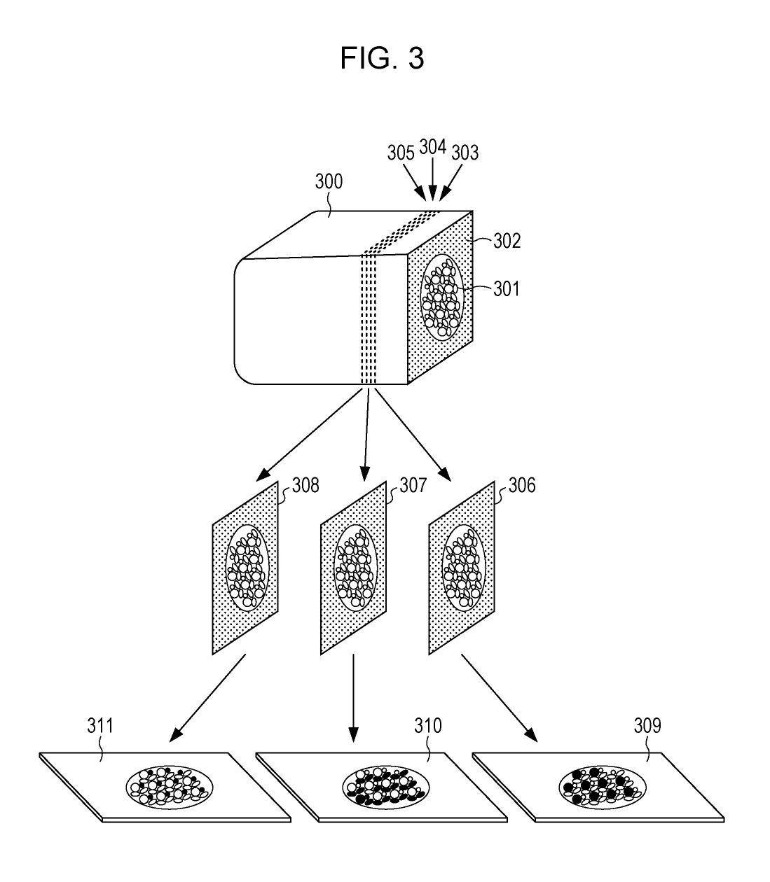

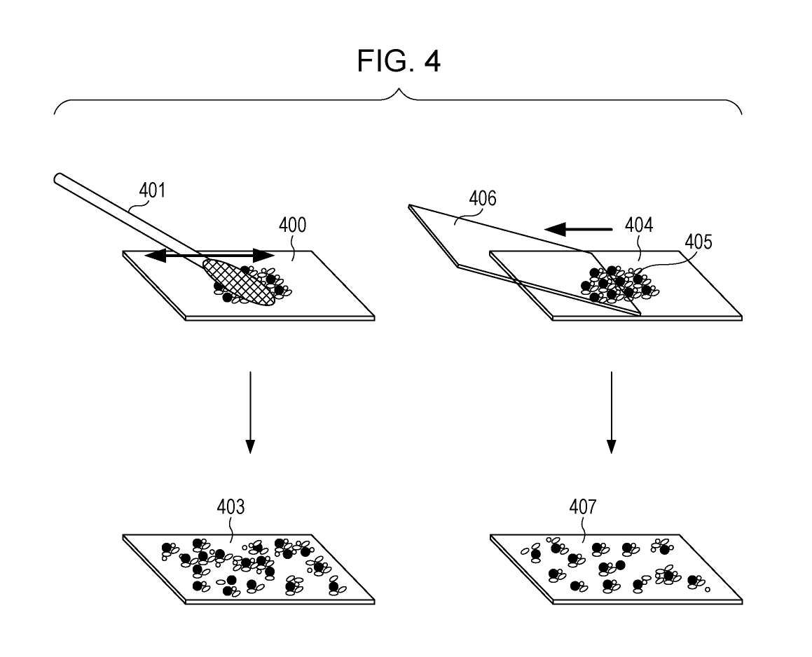

Examples of the preparation 101 which is an object to be photographed in the first embodiment will be described with reference to FIGS. 3 and 4. In the description with reference to FIGS. 3 and 4, only a preparation preparing process which is related to the first embodiment will be described, and other processes will be omitted.

FIG. 3 illustrates examples of the preparation 101 which is an object to be photographed according to the first embodiment, and illustrates production examples of preparations that are to undergo diagnosis from tissue cells (hereinafter, referred to as histological diagnosis) used in pathological diagnosis. Preparations that are to undergo histological diagnosis are prepared to observe a histological structure of a specimen and individual cell shapes.

A paraffin block 300 is obtained by embedding a specimen 301 that is cut in an operation, in paraffin 302 in order to slice the specimen 301. Typically, when preparations are prepared for pathological diagnosis, a specimen is sliced so that a sample which is to be mounted on a glass slide is sufficiently thin with respect to the thickness of a cell. Therefore, it is possible to regard samples that are obtained by successively slicing a specimen, as sections of almost the same cells. Samples 306 to 308 are obtained by slicing the paraffin block 300 at successive cutting positions 303 to 305. Preparations 309 to 311 are obtained by removing paraffin from the samples 306 to 308, adding different stains or fluorescence agents to the resulting samples 306 to 308 which are mounted on glass slides, and then putting cover slips on the glass slides. By observing magnified or demagnified images of the sample of each of the preparations, various types of information useful for diagnosis can be obtained. Further, as apparent from the preparations 309 to 311, observation is performed by comparing states of almost the same cells by using different stains or fluorescence agents, enabling different types of information useful for diagnosis. As described above, comparative observation of magnified or demagnified results of a sample at various positions in a single preparation or comparative observation among preparations prepared by different preparing methods are important to obtain information useful in pathological diagnosis.

FIG. 4 illustrates other examples of the preparation 101 which is an object to be photographed according to the first embodiment, and illustrates production examples of preparations that are to undergo diagnosis from exfoliated cells (hereinafter, referred to as cytological diagnosis) used in pathological diagnosis. A preparation that is to undergo cytological diagnosis cannot be used to observe the histological structure of a specimen, but is prepared to observe shapes of cells rubbed off from a tissue surface or individual cells floating in a body fluid. A slide 400 is a glass slide. A tool 401, such as a cotton swab or a spatula, is used to collect cells, and by rubbing the surface of a site from which cells are to be obtained, cells on the tissue surface are collected. After that, while being pressed against the glass slide 400, the tool 401 to which cells are attached is moved so that the cells are applied to the glass slide 400, and then staining is performed, whereby a preparation 403 is prepared. There are several types of methods for preparing a preparation that is to undergo cytological diagnosis, and another typical method will be described below. A viscous liquid sample 405, such as sputum, is applied onto a glass slide 404. Then, another glass slide 406 is used to spread the sample 405 uniformly, and then staining is performed, whereby a preparation 407 is prepared.

As described above, primary examples of the preparation 101 which is an object to be photographed and observed are described with reference to FIGS. 3 and 4. Preparations that are to undergo histological diagnosis and that are described with reference to FIG. 3 are prepared in a state in which the tissue structure of an organ in a specimen is preserved. Not only are shapes of individual cells observed, but also observation of the position in tissue in which a cancer is present and wide-range observation of a sample, such as observation for an extent of invasion of a cancer, are performed. In contrast, in a preparation that is to undergo cytological diagnosis and that is described with reference to FIG. 4, cells in a sample are applied on a glass slide in such a manner that clusters each having about several to several tens of cells are scattered in a wide area. Therefore, the tissue structure in which the organ was formed by the cells is not preserved. Unlike the preparations that are to undergo histological diagnosis and that are described with reference to FIG. 3, it is difficult to observe the tissue structure. That is, in the case where a preparation that is to undergo cytological diagnosis is observed, observation of the entire sample is less important, and the main purpose is to check the positions of cells of interest on the preparation. Further, in the case of a preparation that is to undergo cytological diagnosis, collected cells are applied onto a glass slide as they are. Accordingly, the cells are thicker than those in preparations that are to undergo histological diagnosis and that are prepared through slicing. Furthermore, the collected cells may be stacked on top of one another. The objective lens of a typical microscope has a very shallow depth of field and a narrow range of focus in the depth direction. Therefore, even when a cluster of one cell is observed in cytological diagnosis, it may be necessary to observe the cluster while the focal position is being changed.

As described above, the preparation methods and the observation methods for the preparations that are to undergo especially pathological diagnosis significantly differ in accordance with their usage. An object of the first embodiment is to facilitate the above-described observation operations by changing a screen layout in accordance with usage.

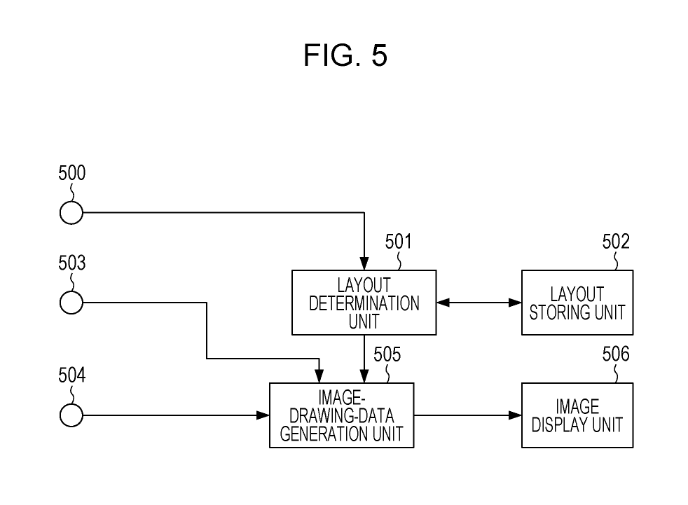

FIG. 5 is a functional block diagram of the image display method according to the first embodiment. An input terminal 500 is a display mode input terminal for receiving a display mode. A layout determination unit 501 serves as a display layout determination unit, and determines a layout, i.e., layout information, used when display is performed on a screen, among layouts, i.e., pieces of layout information, stored in advance in a layout storing unit 502, on the basis of the display mode information received from the display mode input terminal 500. An input terminal 503 is an operation instruction input terminal for receiving an operation instruction about the display, and receives an operation instruction about image display, such as an instruction to change a display position or an instruction to change a display magnification, which is specified by a user by using the keyboard 109, the mouse 110, or the like. An input terminal 504 is an image input terminal for receiving image data to be displayed. An image-drawing-data generation unit 505 generates image drawing data for displaying an image, on the basis of the operation instruction received from the operation instruction input terminal 503 and the layout determined by the layout determination unit 501. An image display unit 506 displays the image drawing data generated by the image-drawing-data generation unit 505.

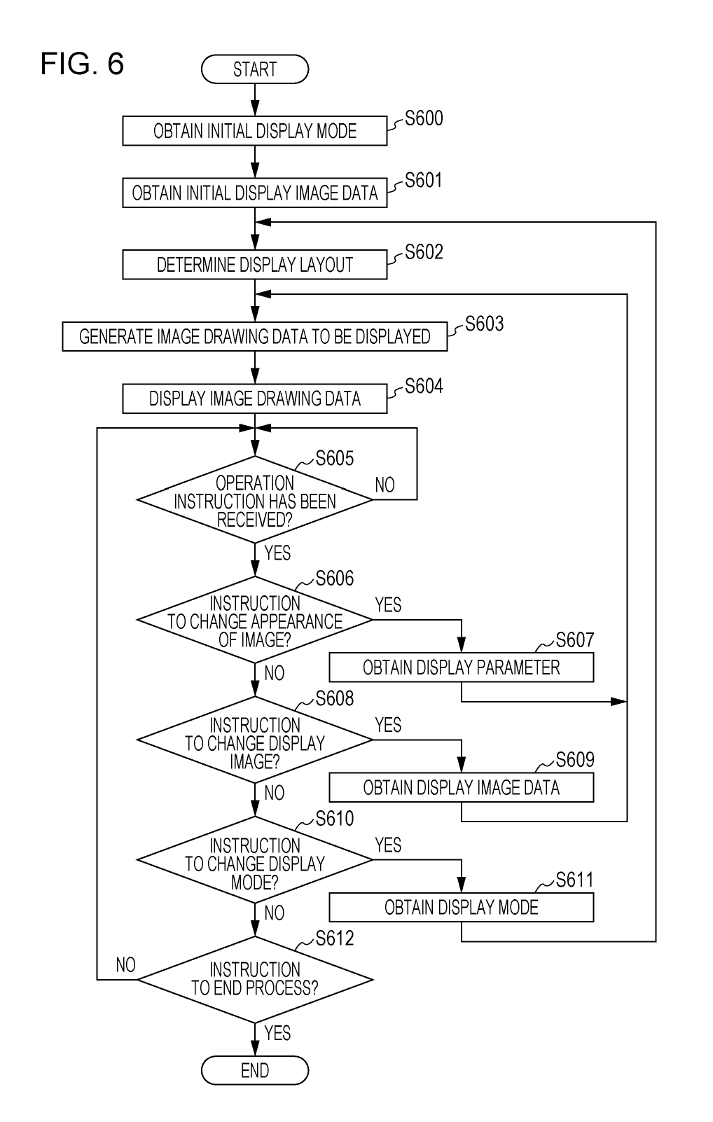

FIG. 6 is a flowchart describing an operation flow of the image display method according to the first embodiment. When the process is started, an initial display mode is obtained in step S600. In step S600, initial display parameters, such as an initial display magnification and an initial display position, for displaying an image are also obtained. In step S601, initial display image data is obtained. The initial display mode, the initial display parameters, and the initial display image data may be determined in advance or may be selected by a user before the initial display. In step S602, a display layout is determined from the layouts stored in advance, on the basis of the display mode obtained in step S600. In step S603, image drawing data is generated to display the image data obtained in step S601 on the display 108, on the basis of the display layout determined in step S602 and the display parameters obtained in step S600. In step S604, display is performed by using the image drawing data generated in step S603.

In step S605, it is determined whether or not an operation instruction has been received from a user. If no operation instructions have been received, the process repeatedly waits until an operation instruction is received. If an operation instruction has been received, the process proceeds to step S606, and it is determined whether or not the operation instruction is an instruction to change the appearance of an image. Typical examples of the change of appearance an image are a change of the display magnification and a move of the display position. However, the change of appearance of an image may be any change, such as specifying of an area of interest or a change in contrast, as long as the instruction is one to change appearance of an image. If it is determined that the operation instruction is an instruction to change appearance of an image in step S606, a display parameter is obtained from the instruction in step S607. Then, the process proceeds to step S603, and image drawing data to be displayed is generated on the basis of the display parameter obtained in step S607. If it is determined that the operation instruction is not an instruction to change appearance of an image in step S606, the process proceeds to step S608, and it is determined whether or not the operation instruction is an instruction to change the display image. If it is determined that the operation instruction is an instruction to change the display image in step S608, the process proceeds to step S609, and display image data is obtained on the basis of the instruction. Then, the process returns back to step S603, and image drawing data to be displayed is generated. If it is determined that the operation instruction is not an instruction to change the display image in step S608, the process proceeds to step S610, and it is determined whether or not the operation instruction is an instruction to change the display mode. If it is determined that the operation instruction is an instruction to change the display mode in step S610, a display mode is obtained from the instruction in step S611. Then, the process proceeds to step S602, and a display layout is determined on the basis of the display mode obtained in step S611. If it is determined that the operation instruction is not an instruction to change the display mode in step S610, the process proceeds to step S612, and it is determined whether or not the operation instruction is an instruction to end the process. If it is determined that the operation instruction is an instruction to end the process in step S612, the process is ended. If it is determined that the operation instruction is not an instruction to end the process, the process proceeds to step S605, and waits again until an operation instruction is received.

In FIG. 6, only operation instructions which are necessary for the first embodiment are described. However, other operation instructions may be included. In this case, an additional flow may be added in which, if it is determined that the operation instruction is other than an instruction to end the process in step S612, a process corresponding to the operation instruction is performed.

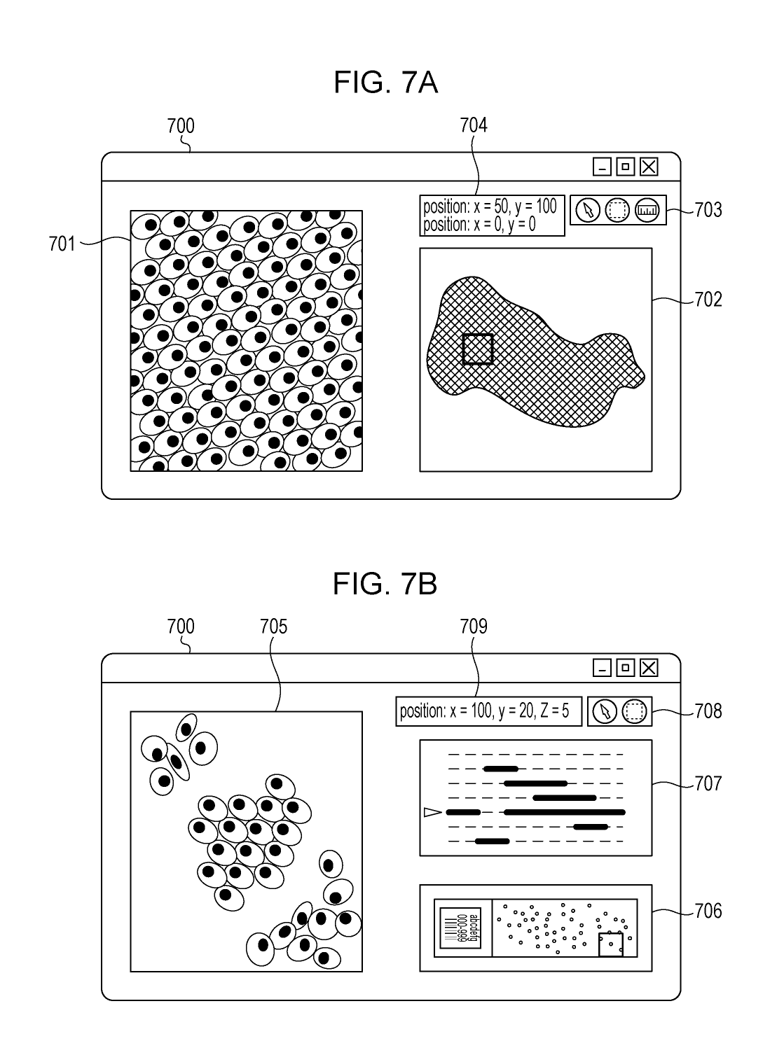

Display layouts which are characteristics of the first embodiment will be described with reference to FIGS. 7A and 7B. FIG. 7A illustrates an exemplary first layout which is desirable for displaying an image obtained by photographing a preparation that is to undergo histological diagnosis as described above. FIG. 7B illustrates an exemplary second layout which is desirable for displaying an image obtained by photographing a preparation that is to undergo cytological diagnosis as described above. Whether the layout in FIG. 7A or that in FIG. 7B is to be displayed is determined in step S602 in FIG. 6. The layout is switched in accordance with the display mode specified by a user.

In FIG. 7A, an application window 700 is displayed on the display 108. A first image display area 701 is an area for displaying an image specified by a user. In a second image display area 702, the same image as the image displayed in the first image display area 701 is displayed at a different display magnification. In the example in FIG. 7A, the display magnification for the first image display area 701 is higher than that for the second image display area 702. As described with reference to FIGS. 3 and 4, in the observation of preparations that are to undergo histological diagnosis, not only observation of individual cells but also observation of the tissue structure is important. Since the display magnification for the observation of individual cells is different from that for the observation of the tissue structure, as in the configuration of the first and second image display areas 701 and 702 in FIG. 7A, display areas are displayed parallel to each other at different display magnifications in order to perform comparative observation, enabling the image observation operation in the diagnosis to be efficiently performed. A tool selection area 703 is an area for selecting a tool for aiding in operations during image observation. A display-information display area 704 is an area for displaying the display positions that are the display positions of the first and second image display areas 701 and 702 in the displayed image and that are in a photographed image plane (hereinafter, represented by x and y coordinates), as x-y coordinates values. In the display-information display area 704, not only the display positions, but also display magnifications of the images may be displayed. In addition, information other than the display positions, such as operations performed by using tools selected in the tool selection area 703, may be displayed.

A display layout used when an image obtained by photographing a preparation that is to undergo cytological diagnosis is displayed will be described with reference to FIG. 7B. A first image display area 705 is an area for displaying an image specified by a user. A preparation display area 706 is an area for displaying the entire image of a preparation that is being observed. A z-position display area (vertical-direction position display area) 707 is an area for indicating the state of image planes photographed at different z positions in the direction (hereinafter, represented by z coordinate) perpendicular to an image plane (image pickup surface). In the z-position display area 707, not only are z positions displayed, but also, for example, information about ranges in which cells are focused, in images at z positions (e.g., ranges which are determined on the basis of positions at which contrast is high, positions at which edge components of the images are steep, or the like) may be displayed.

Like the tool selection area 703 in FIG. 7A, a tool selection area 708 is an area for selecting a tool for aiding in operations during image observation. Like the display-information display area 704, a display-information display area 709 is an area for displaying information about the image display.

As described with reference to FIGS. 3 and 4, individual cells are scattered as a certain number of clusters on a preparation that is to undergo cytological diagnosis, in such a manner that no tissue structures exist in the cells. Therefore, as illustrated in the example in the image display area 705, importance is placed on observation of only individual cells, whereas observation using an image having a different display magnification as in the second image display area 702 is not always necessary. In the case of a preparation which is to undergo cytological diagnosis and in which the tissue structure is broken, it is difficult to represent the x and y positions of a cell of interest by using positions other than those on the preparation. Accordingly, instead of the second image display area 702 for displaying an image at a different display magnification, the preparation display area 706 for displaying the entire image of the preparation may be provided in order to locate the position of a cell of interest. Further, since cells in a preparation that is to undergo cytological diagnosis are not sliced, the cells are thick and may be further stacked on top of one another in the z direction in a cell cluster. As described above, a typical microscope has a significantly shallow depth of field. Accordingly, in the case where cells included in a single cell cluster are to be observed, when only an image captured at a certain z position is used, it may not be possible to achieve focusing, resulting in failure to observe the cells. That is, only setting of x and y positions according to an operation instruction may cause failure to display a cell that is to be displayed. Accordingly, by providing the z-position display area 707, the z position with respect to an x-y position which is on the preparation and which is in the image displayed in the image display area 705 can be determined, and the display position of a cell that is to be displayed can be determined. In FIG. 7A, since the second image display area 702 is provided in order to observe an image, a wide display area is necessary to some degree. In contrast, in FIG. 7B, since the main purpose of the preparation display area 706 and the z-position display area 707 is to locate a position, these areas may have a display area that is large enough to check a position. Accordingly, the preparation display area 706 and the z-position display area 707 may be smaller than the second image display area 702. When the layout is switched, the layout in the area in which the second image display area 702 is displayed may be changed so that the preparation display area 706 and the z-position display area 707 are displayed. It goes without saying that the display range of the second image display area 702 illustrated in FIG. 7A does not necessarily match that of the preparation display area 706 and the z-position display area 707 illustrated in FIG. 7B completely, and that the positions may be displaced when the layout is changed. In the examples in FIGS. 7A and 7B, the first display area 701 or 705 is located on the left side in the application window 700, whereas the second image display area 702, the preparation display area 706, and the z-position display area 707 are located on the right side in the application window 700. However, the display positions of the display areas in the window are not limited to these. Further, the display position of the first display area 705 may be changed after the layout is changed. The layout may be determined in consideration of the sizes and the aspect ratios of the preparation display area 706 and the z-position display area 707.

The display contents in the tool selection areas 703 and 708 may be changed in accordance with the layout change. For example, in the case where an image of a preparation that is to undergo histological diagnosis is observed, when a cancer is found, there may be a need to measure the distance in which the invasion of cancer cells extends from the epidermis. In this case, a measurement tool for measuring a length is very useful. In contrast, in the case where an image of a preparation that is to undergo cytological diagnosis is observed, there is no need to measure the invasion distance of cancer cells, so that a measurement tool is not so useful. Therefore, switching may be performed so that, for example, a measurement tool is displayed only in the layout for observation for histological diagnosis. In contrast, a tool which is displayed only in observation for cytological diagnosis may be present. For example, various cells are scattered on a preparation that is to undergo cytological diagnosis. Therefore, it is difficult to find the position of a cell to be checked. Accordingly, to increase diagnosis efficiency, marking may be performed in advance by using a permanent marker at the position of a cell that is required to be checked, when a preparation is prepared. For an image obtained by photographing such a preparation that carries a marking, the marking position is detected, and the vicinity of the marking position is displayed, enabling diagnosis efficiency to be increased. Therefore, in the layout for cytological diagnosis, a marking position detection tool may be displayed in the tool selection area 708. The example of the process of the marking position detection tool is a process of extracting an area which has a color that is registered in advance and which is larger than a predetermined size, as a marking. However, other methods may be employed. Further, for example, an area surrounded by extracted marking positions may be displayed with a high priority.

In the present embodiment, switching of display contents in the tool selection areas 703 and 708 is not limited to these, and other various tools may be switched from one to another in accordance with the purposes of layouts.

Further, the display content in the display-information display areas 704 and 709 may be changed in accordance with the layout change. For example, as described above, in the case of FIG. 7A which illustrates the layout for histological diagnosis, the display positions of the two image display areas 701 and 702 are displayed in x-y coordinates in the display-information display area 704. In contrast, in the case of FIG. 7B which illustrates the layout for cytological diagnosis, since there is only one image display area, only one x-y coordinates may be displayed. However, in observation for cytological diagnosis, a display range may be required to be determined, including a z position as described above. Accordingly, x-y-z coordinates may be displayed in the display-information display area 709.

As described above, according to the first embodiment, a user specifies a display mode which indicates observation for histological diagnosis or observation for cytological diagnosis, enabling the display layout to be changed. As a result, when either of image observation for histological diagnosis and that for cytological diagnosis is performed, observation operations can be performed on a layout screen on which a display suitable for the operations is performed, enabling efficiency of observation operations performed by a user to be increased.

### Second Embodiment

In the first embodiment, the example is described in which the display layout is changed on the basis of a display mode specified by a user, whereby display can be performed in a display layout suitable for histological diagnosis or cytological diagnosis. In a second embodiment, an example will be described in which a layout is determined on the basis of associated information of an image to be displayed.

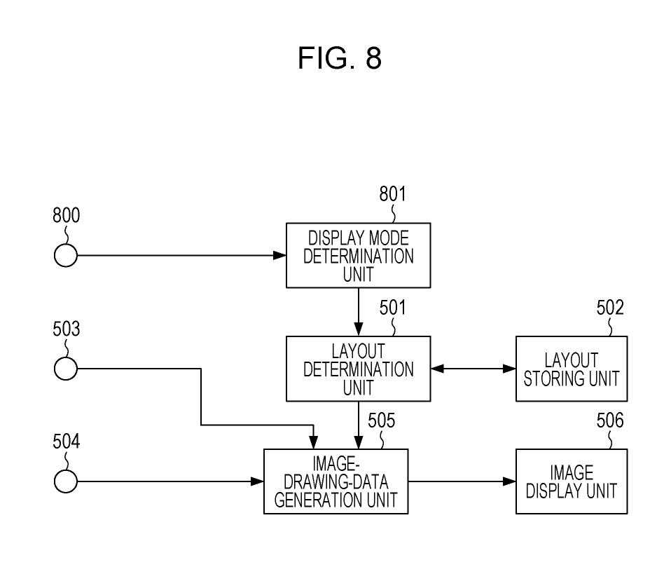

FIG. 8 is a functional block diagram of an image display method according to the second embodiment. In the description below, components that are similar to those in FIG. 5 which is a block diagram for the first embodiment are designated with the identical reference numerals, and will not be described. In FIG. 8, an associated-information input terminal 800 serves as an input unit that receives associated information. A display mode determination unit 801 determines a display mode on the basis of the associated information received by the associated-information input terminal 800. The layout determination unit 501 determines a display layout on the basis of the display mode determined by the display mode determination unit 801.

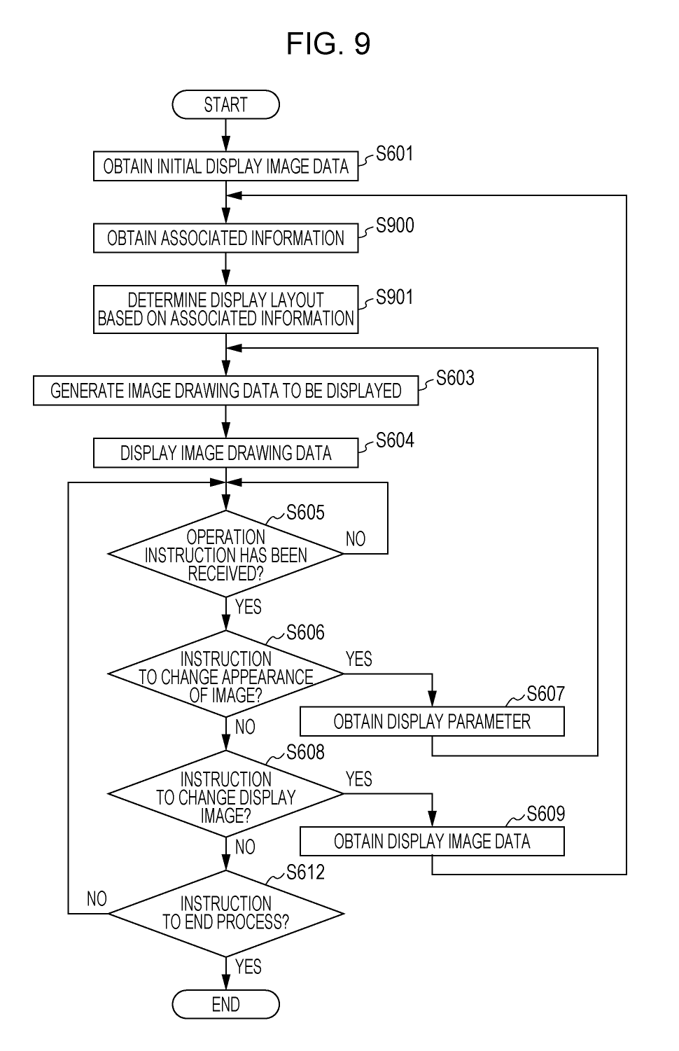

FIG. 9 is a flowchart describing an operation flow of the image display method according to the second embodiment. In the description below, steps that are similar to those in FIG. 6 which is a flowchart for the first embodiment are designated with the identical reference characters, and will not be described. In FIG. 9, steps S602, S610, and S611, which are not used in the second embodiment, among the steps in FIG. 6 are not illustrated.

In FIG. 9, when initial display image data is obtained in step S601, or display image data is obtained on the basis of a change instruction from a user in step S609, associated information of the display image data is obtained in step S900. Typically, for example, the associated information is recorded in a file that includes image data, or is recorded in a separate file in such a manner as to be associated with image data. The associated information associated with the obtained image data is obtained. In step S901, a display layout is determined on the basis of the associated information obtained in step S900. Then, the process proceeds to step S603, and similar processes described with reference to FIG. 6 are performed.

Examples of the associated information include information indicating an object photographed to capture an image. For example, the intended use of a preparation described with reference to FIGS. 3 and 4 is clear at the time point when the preparation is prepared, e.g., for histological diagnosis or for cytological diagnosis. Therefore, when a preparation is photographed to capture image data, the intended use of the preparation (viewed from another side, possibly regarded as the production purpose of the preparation) is also recorded as associated information. As in the second embodiment as described above, information about the intended use is used as associated information, enabling display to be performed in a layout suitable for the intended use when an image is observed.

An example of associated information may be information from which the intended use can be assumed, other than the above-described intended use. For example, information about the preparation preparing process may be information obtained when a sample is mounted on a glass slide, such as whether or not slicing is performed, or whether or not a cotton swab is used to apply a sample. Instead, the way of collecting a specimen may be used, such as whether or not the specimen is cut in an operation, or whether it is collected from a body fluid or through rubbing. Further, staining is performed to facilitate a visual check, when a preparation is prepared. Information about how to perform staining may be used. Any information from which the intended use can be assumed may be applied to the associated information. Information from which the intended use can be assumed may translate into information from which the intended use is presumed.

The layout may be switched on the basis of the associated information other than the intended use. For example, information about the thickness of a preparation or a specimen, or information about the number of images captured while the position in the direction perpendicular to the image plane is being changed (or information equivalent to the number of images, such as “the number of shooting positions”) may be used.

In this case, e.g., in the case where the object in a preparation, i.e., a sample, has a thickness equal to or larger than a predetermined value, or in the case where images, the number of which is a predetermined value or more, are present in the depth direction, it may be determined that importance is to be placed on observation in a direction perpendicular to the image plane. In contrast, in the case where the thickness or the number of images is less than the predetermined value, for example, it may be determined that the layout is to be switched so that importance is placed on observation in the planar direction.

In the case where images are present in the direction perpendicular to the image plane, information indicating the size of an image, such as the size of a photographed surface on a preparation or a sample, or the resolution or the number of pixels of an image, may be further taken into account. In the case where the size of an image is equal to or larger than a predetermined value, it is determined that importance is to be placed on observation in the planar direction. In contrast, in the case where the size of an image is smaller than the predetermined value, it is determined that importance is to be placed on observation in the direction perpendicular to the image plane, and the layout may be switched.

As a matter of course, multiple pieces of information may be used as the associated information. For example, the associated information used herein may include at least one of the following pieces of information: information about the intended use of a sample; information from which the intended use of a sample is assumed; information about the thickness of a preparation or a sample; information indicating the number of images in the direction perpendicular to the image plane; information about the size of a photographed surface on a preparation or a sample; information about the resolution of an image; and information about the number of pixels of an image.

Further, in the case where the size of an image is equal to or larger than a predetermined value and where images are present in the direction perpendicular to the image plane, it is possible to perform both of observation in the planar direction and observation in the direction perpendicular to the image plane. Therefore, it may be determined that importance is to be placed on observation in the planar direction at first, and the layout may be determined. After that, a user may change the layout through an operation.

As described above, according to the second embodiment, associated information associated with image data to be displayed enables the screen layout used when the image is displayed, to be changed. Thus, without selection performed by a user, observation operations can be performed in a screen layout that allows display suitable for the operations, enabling efficiency of observation operations performed by a user to be increased.

### Third Embodiment

In the first or second embodiment described above, the example is described in which, when the layout is to be switched, a layout is determined through specification performed by a user or by using associated information of an image to be displayed.

In the embodiments described above, change of the first image display areas 701 and 705 in FIGS. 7A and 7B is not described other than change of the position on a layout. By switching the way of displaying the first image display areas 701 and 705 in accordance with the purpose, comparative observation may be easily performed also when images are compared with each other. Accordingly, in a third embodiment, an exemplary layout that is optimal in the case where observation is performed while displayed images are being compared with each other will be described.

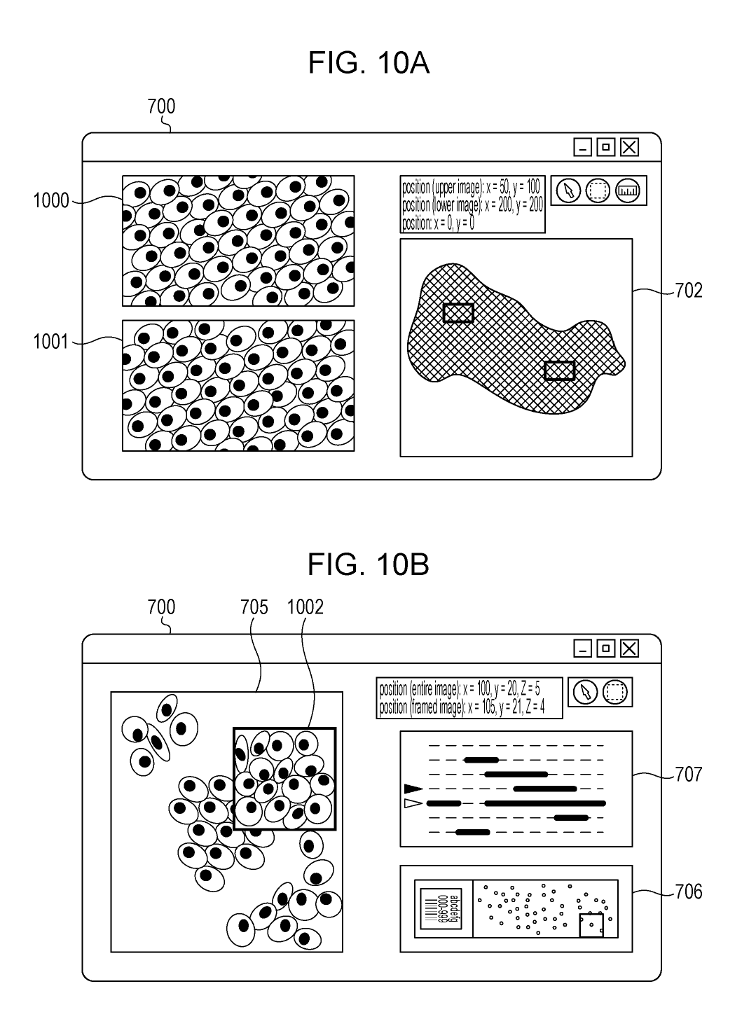

In histological diagnosis, cancer cells having a similar shape may be scattered in the same sample, and final diagnosis may be made after cells located at multiple positions are compared with each other in the same sample. Alternatively, as described with reference to FIG. 3, different types of staining are performed on adjacent slices after slicing, whereby the different types of staining can be performed on almost the same cells. Accordingly, comparison may be made by using results obtained by performing the different types of staining on almost the same cells. In this case, the first image display area 701 is divided, and images to be compared with each other are displayed so as to be parallel to each other, enabling efficiency of image observation operations to be increased. FIG. 10A illustrates an exemplary layout that is desirable for comparative observation performed when image observation for histological diagnosis is performed. In FIG. 10A, instead of the first image display area 701, image display areas 1000 and 1001 are displayed so as to be parallel to each other and to be located at such positions that comparison is easily performed. The layout in FIG. 7A may be changed into that in FIG. 10A when a second display position or a second image to be displayed is selected in the display state in FIG. 7A. An example of how to select a second display position is a method in which a different position is selected in the second image display area 702. Another example is a method in which an area of interest is registered in advance when observation is being performed in the first image display area 701 and in which the registered area is selected as an area for comparison.

In cytological diagnosis, cells in a preparation do not always come off the same tissue, and cells that come off various pieces of tissue are likely mixed in a preparation.

Unlike the case of histological diagnosis, it is difficult to observe the states of cells at the same position by performing multiple types of staining. In cytological diagnosis, as described above, different cells may be observed, not only when the observation position is shifted in the x-y plane, but also when only the z position is shifted. Therefore, in the case where cells included in the same cell cluster are observed, observation performed while comparison is being performed at the same x-y position and at multiple z positions enables efficiency of image observation operations to be increased. FIG. 10B illustrates an exemplary layout that is desirable for comparative observation performed when image observation for cytological diagnosis is performed. An image display area 1002 is an area that is specified by a user and that is included in the first image display area 705. In the image display area 1002, an image at a z position that is different from that of the other area in the first image display area 705 can be selectively displayed.

In FIG. 10B, the image display area 1002 is illustrated as a rectangular area. However, the shape of the area is not limited to this, and a polygon other than a rectangle, an ellipse, or an area selected by a user without any restriction may be used.

Further, in the case where cells that are substantially stacked on top of one another in the z direction are comparatively observed, it is desirable that areas that are located at different z positions and at the same x-y position and that correspond to an image area which is to be subjected to comparative observation can be displayed so as to be parallel to each other. Accordingly, in the display state in FIG. 10B, the x-y position of an image displayed in the image display area 1002 may be fixed so as to be independent of the position of the image display area 1002, and the display position of the image display area 1002 on the screen may be changeable.

In the layout in FIG. 10B, in the case of cytological diagnosis involving cells that have different focusing positions in the z direction, observation is easily performed while cells included in a cluster constituted by cells of the same tissue are being compared with each other.

Embodiments of the present invention are not limited to those embodiments described above, and various modifications and changes can be made within the scope of the present invention.

The layout is also changed by using information other than that obtained when a preparation is prepared. For example, since there is a possibility of reappearance of a cancer, a preparation prepared for the current diagnosis may be compared to an image of a preparation that was prepared for a past diagnosis. Another example is that a preparation that indicates a similar case and that is prepared by using a sample from another person may be referred to as a comparison reference. In this case, since the shapes of samples that are cut when the preparations are to be prepared are different from each other, multiple images are required to be displayed in the second image display area 702. Accordingly, a display mode for such an operation purpose may be provided so that multiple second image display areas 702 are displayed. In addition, since individual display areas are made narrow when the number of display areas increases, a second image display area 702 may be invisible, or may be made visible or invisible at a desired timing through an instruction. In the case where an image is to be displayed as a reference for comparison, an additional first image display area may be temporarily displayed, and may be removed as soon as it becomes unnecessary. The area that is temporarily displayed may be movable, and may be displayed in such a manner as to overlap another display area that is not referenced during the temporary observation.

Further, other than the exemplary layouts illustrated in FIGS. 7A, 7B, 10A, and 10B, the layouts stored in the layout storing unit 502 may be layouts for histological diagnosis and for cytological diagnosis which can be edited in advance by a user. Specifically, for example, in histological diagnosis, the number of preparations, or the staining method, the method of comparing cells, or the like may depend on an organ from which a sample is collected. Accordingly, a layout may be obtained in such a manner that a user edits, in advance, the locations and sizes of the image display areas, and display contents, other than image display, and positions of the tool selection area and the like, so as to facilitate comparison, and the layout may be stored and used.

The description is made in which the embodiments described above are achieved by using programs executed by the CPU 200. However, the embodiments of the present invention are not limited to this. For example, part or the entirety of the configuration described above may be achieved by hardware.

Further, the embodiments of the present invention are achieved not only in the terminal 107 connected to the display 108 but also in another terminal that is connected via a network and that generates image drawing data. The image drawing data transmitted via the network may be displayed on the display 108. That is, the embodiments of the present invention can be applied to a system configuration in which the site in which image drawing data is generated is remote from the site in which an image is displayed on a display.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a non-transitory computer-readable storage medium). In such a case, the system or apparatus, and the recording medium where the program is stored, are included as being within the scope of the present invention.

According to one aspect of the present invention described above, an image-drawing-data generation apparatus can determine a layout in accordance with an object photographed to capture an image or the purpose of image observation. As a result, an image can be displayed in a layout suitable for the image observation operations, enabling efficiency of the image observation operations to be increased.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-033154 filed Feb. 17, 2012, which is hereby incorporated by reference herein in its entirety.

What is claimed is:

1. An image-drawing-data generation apparatus comprising:
an image input unit configured to receive information about an image obtained by photographing a sample containing a cell;
a layout storing unit configured to store a plurality of layouts;
a display layout determination unit configured to determine a display layout, from among the plurality of layouts, that is displayed when the image is to be displayed; and
an image-drawing-data generation unit configured to generate image drawing data to be displayed based on the information about the image and the display layout,
wherein the plurality of layouts include a first layout for observing the image obtained by photographing the sample that holds a tissue structure, and a second layout for observing the image obtained by photographing the sample that does not hold a tissue structure.

2. The image-drawing-data generation apparatus according to claim 1,
wherein the display layout determination unit determines the display layout from among the plurality of layouts in accordance with a display mode.

3. The image-drawing-data generation apparatus according to claim 2, further comprising:
a display mode input unit configured to receive the display mode,
wherein the display layout determination unit determines the display layout based on the display mode received by the display mode input unit.

4. The image-drawing-data generation apparatus according to claim 2, further comprising:
an associated information input unit configured to receive associated information of the image; and
a display mode determination unit configured to determine the display mode,
wherein the display mode determination unit determines the display mode based on the associated information.

5. The image-drawing-data generation apparatus according to claim 2,
wherein each of the first and second layouts includes a tool selection area for selecting a tool for aiding in an image observation operation, and
wherein the display layout determination unit determines a tool to be displayed in the tool selection area in accordance with the display mode.

6. The image-drawing-data generation apparatus according to claim 2,
wherein each of the first and second layouts includes a display-information display area for displaying information about image display, and
wherein the display layout determination unit determines information to be displayed in the display-information display area in accordance with the display mode.

7. The image-drawing-data generation apparatus according to claim 1,
wherein each of the first and second layouts includes a first image display area and a second image display area whose display magnification is lower than the display magnification of the first image display area.

8. The image-drawing-data generation apparatus according to claim 7,
wherein the size of the second image display area in the first layout is larger than the size of the second image display area in the second layout.

9. The image-drawing-data generation apparatus according to claim 1,
wherein the second layout enables images to be selectively displayed, the images being captured at a plurality of positions in a direction perpendicular to an image pickup surface of the image that is being displayed in a first image display area.

10. The image-drawing-data generation apparatus according to claim 9,
wherein the second layout includes a vertical-direction position display area for displaying a position of the image displayed in the first image display area from among the images captured at the plurality of positions.

11. A method for generating image drawing data, the method comprising the steps of:
receiving information about an image obtained by photographing a sample containing a cell;
determining a display layout, from among a plurality of layouts, that is displayed when the image is to be displayed; and
generating image drawing data to be displayed based on the information about the image and the display layout,
wherein the plurality of layouts include a first layout for observing the image obtained by photographing the sample that holds a tissue structure, and a second layout for observing the image obtained by photographing the sample that does not hold a tissue structure.

12. A computer-readable storage medium storing a program that causes a computer to execute the steps of the method according to claim 11.

13. An image-drawing-data generation system comprising:
a display apparatus; and
an image-drawing-data generation apparatus,
wherein the image-drawing-date generation apparatus comprises:
an image input unit configured to receive information about an image obtained by photographing a sample containing a cell;
a layout storing unit configured to store a plurality of layouts;
a display layout determination unit configured to determine a display layout, from among the plurality of layouts, that is displayed when the image is to be displayed on the display apparatus, and
an image-drawing-data generation unit configured to generate image drawing data to be displayed on the display apparatus based on the information about the image and the display layout, and
wherein the plurality of layouts include a first layout for observing the image obtained by photographing the sample that holds a tissue structure, and a second layout for observing the image obtained by photographing the sample that does not hold a tissue structure.

14. An image-drawing-data generation apparatus comprising:
an image input unit configured to receive information about an image obtained by photographing a sample containing a cell;
an associated information input unit configured to receive associated information of the image;
a layout storing unit configured to store a plurality of layouts;
a display layout determination unit configured to determine a display layout, from among the plurality of layouts, that is displayed when the image is to be displayed; and
an image-drawing-data generation unit configured to generate image drawing data to be displayed based on the information about the image and the display layout,
wherein the display layout determination unit determines the display layout from among the plurality of layouts based on the associated information, and
wherein the associated information includes at least one of information about intended use of the sample, information from which the intended use of the sample is presumed, information about a thickness of a preparation or a thickness of the sample, information about the number of images in a direction perpendicular to an image plane, information about a size of a photographed surface on the preparation or on the sample, information about a resolution of the image, and information about the number of pixels in the image.

15. A method for generating image drawing data, the method comprising the steps of:
receiving information about an image obtained by photographing a sample containing a cell;
receiving associated information of the image;
determining a display layout, from among a plurality of layouts, that is displayed when the image is to be displayed; and
generating image drawing data to be displayed based on the information about the image and the display layout,
wherein, in the determining step, the display layout is determined from among the plurality of layouts based on the associated information, and
wherein the associated information includes at least one of information about intended use of the sample, information from which the intended use of the sample is presumed, information about a thickness of a preparation or a thickness of the sample, information about the number of images in a direction perpendicular to an image plane, information about a size of a photographed surface on the preparation or on the sample, information about a resolution of the image, and information about the number of pixels in the image.

16. A computer-readable storage medium storing a program that causes a computer to execute the steps of the method according to claim 15.

17. An image-drawing-data generation system comprising:
a display apparatus; and
an image-drawing-data generation apparatus,
wherein the image-drawing-data generation apparatus comprises:
an image input unit configured to receive information about an image obtained by photographing a sample containing a cell;
an associated information input unit configured to receive associated information of the image;
a layout storing unit configured to store a plurality of layouts;
a display layout determination unit configured to determine a display layout, from among the plurality of layouts, that is displayed when the image is to be displayed on the display apparatus, and
an image-drawing-data generation unit configured to generate image drawing data to be displayed on the display apparatus based on the information about the image and the display layout,
wherein the display layout determination unit determines the display layout from among the plurality of layouts based on the associated information, and
wherein the associated information includes at least one of information about intended use of the sample, information from which the intended use of the sample is presumed, information about a thickness of a preparation or a thickness of the sample, information about the number of images in a direction perpendicular to an image plane, information about a size of a photographed surface on the preparation or on the sample, information about a resolution of the image, and information about the number of pixels in the image.
